(19) United States
(12) Patent Application Publication
(10) Pub. No.: US 2010/0212277 A1
(43) Pub. Date: Aug. 26, 2010

(54) Crop harvester

(76) Inventor: William R. Marrs, Arkansas City, KS (US)

Correspondence Address: Larry E Severin, Esq, 3581 Teaberry Circle, Seal Beach, CA, 90740, US

(21) Appl. No.: 12/547,267

(22) Filed: Aug. 25, 2009

Related U.S. Application Data
(60) Provisional application No. 61/154,097, filed on Feb. 20, 2009.

(51) Int. Cl. A01D 34/00

(52) U.S. Cl. 56/12.4; 56/14.5

(57) ABSTRACT

A crop harvester includes: a rotatable auger tube having a gathering section; flighting disposed in a spiral pattern on the outer surface of the gathering section so that, when the auger tube is rotated, the flighting moves material within a perimeter of the flighting laterally and creates a neutral zone behind the flighting that is generally free of material; and gathering fingers disposed in the neutral zone that, when the auger tube is rotated, extend beyond the perimeter of the flighting to gather the material, tuck the material toward the auger tube, and then retract within the perimeter of the flighting.

### FILING DATE

This application claims the benefit of the filing date of U.S. Patent Application No. 61/154,097, filed Feb. 20, 2009.

### BACKGROUND OF THE INVENTION

The present invention generally relates to material handling and more specifically to a crop harvester.

Full finger augers available now encourage auger wrapping in tuff or vine crops. They also have the gathering fingers timed parallel with the feeder fingers, so that both types of fingers extend toward the crops at the same time, even though the gathering fingers and finger fingers serve a totally different purpose. The auger-wrapping problem is so bad in vine crops, that manufacturers of full finger augers may recommend removing the center feeder section fingers and adding extension flighting over the feeder section to alleviate the problem.

Conventional fingers located midway between flights are not timed to gather the crop and release it without being in competition with the flighting. This causes side draft on the fingers, resulting in excess maintenance. The conventional full finger harvesters have the fingers clawing rearward while the flighting is moving the crop material laterally toward the feeder section. Existing full finger augers are such that composite or fiberglass fingers only last 200 to 300 hours. The maximum on a conventional full finger auger is typically 20 standard length fingers.

Conventional full finger harvesters also employ a reel to force the crops into the header, which can cause crop shattering.

It would be desirable to have a harvester where the fingers did not interfere with the sideways movement of the crops. It would also be desirable to have a harvester that does not employ a reel.

### SUMMARY OF THE INVENTION

In one aspect of the present invention, a device for collecting material includes: a rotatable auger tube having a gathering section; flighting disposed in a spiral pattern on the outer surface of the gathering section so that, when the auger tube is rotated, the flighting moves material within a perimeter of the flighting laterally and creates a neutral zone behind the flighting that is generally free of material; and gathering fingers disposed in the neutral zone that, when the auger tube is rotated, extend beyond the perimeter of the flighting to gather the material, tuck the material toward the auger tube, and then retract within the perimeter of the flighting.

In another aspect of the present invention, a device for collecting material includes: a rotatable auger tube having a gathering section and a feeder section; flighting disposed in a spiral pattern on the outer surface of the gathering section so that, when the auger tube is rotated, the flighting moves material within a perimeter of the flighting laterally and creates a neutral zone behind the flighting that is generally free of material; gathering fingers that, when the auger tube is rotated, extend beyond the perimeter of the flighting to gather the material, tuck the material toward the auger tube, and then retract within the perimeter of the flighting; apertures disposed in the neutral zone of the gathering section that help guide the gathering fingers into the neutral zone; and retractable feeder fingers in the feeder section that sweep the material into a collection area, the feeder fingers disposed on the feeder section and the gathering fingers disposed on the gathering section so that, when the auger tube is rotated, the maximum extension of the gathering fingers occurs before the maximum extension of the feeder fingers.

In yet another aspect of the present invention, a method for collecting material includes: rotating an auger tube having flighting disposed in a spiral pattern in a gathering section of the auger tube so as to move material toward a feeder section of the auger tube; disposing gathering fingers on the gathering section in a neutral zone behind the flighting that is generally free of material; extending the gathering fingers beyond the perimeter of the flighting so as to receive the material and tuck the material toward the auger tube; and retracting the gathering fingers within the perimeter of the flighting.

### BRIEF DESCRIPTION OF THE DRAWINGS

FIG. 1 depicts a portion of an embodiment of the present invention;

FIG. 2 depicts a continuing portion of an embodiment of the present invention;

FIG. 3 depicts a side view of an embodiment of the present invention showing the relative timing of gathering fingers and feeder fingers;

FIG. 4 depicts a feeder section, and a gathering section in two subsections according to the present invention; and

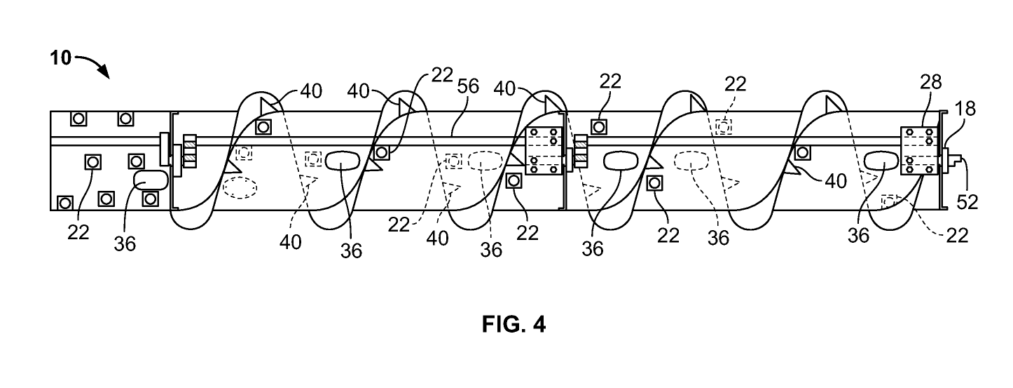

FIG. 5 depicts a detailed view of an embodiment of the crankshafts according to the present invention.

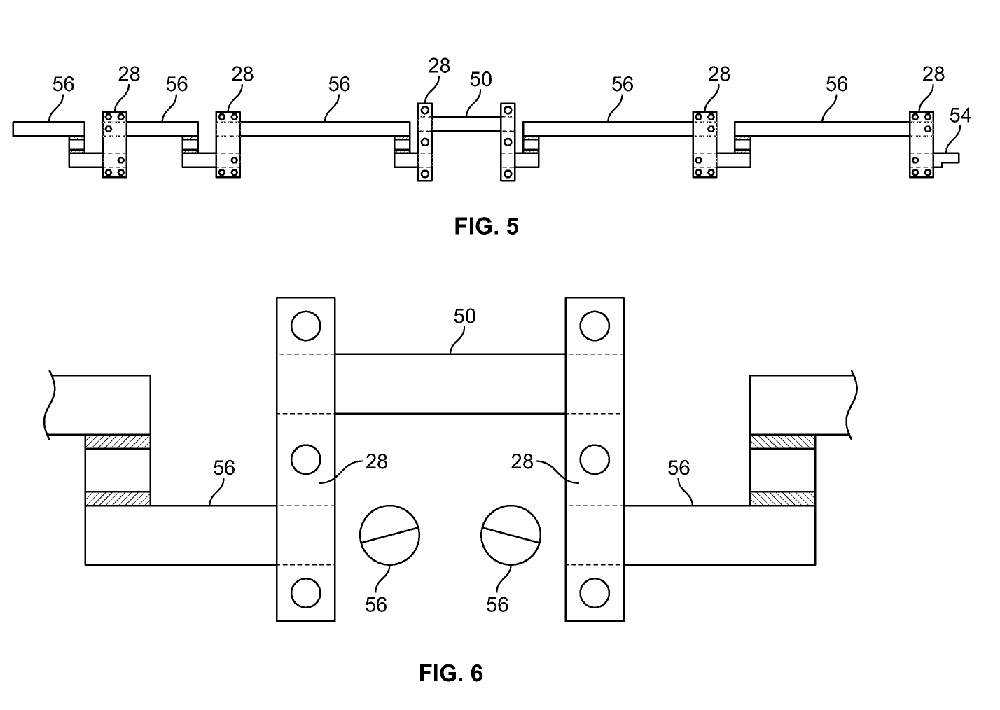

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the invention can harvest beans with minimal auger wrapping and shattering. Reel shattering can be reduced to zero or near-zero.

An embodiment of the present invention locates longer fingers in the crop free neutral area or “neutral zone” on the back side of the flights. The fingers extend beyond the perimeter of the flighting to gather the crop in and tuck it under the auger. The fingers then continue to retract into the neutral zone, inside the radius of the flighting, where they can do no harm.

In an embodiment of the invention, the timing problem can be improved by advancing the flighting fingers 30 degrees ahead of the feeder fingers, so both types of fingers can do the job they are designed for. The auger wrapping problem can be improved by the fact that the fingers are not in contact with the crop material after they gather and tuck, thus allowing the auger to move the material to the feeder section as it was designed to do. The location of the long fingers on the back side of the flighting also allows the use of 44 fingers on a 30 ft. auger. This can increase the gathering ability to double or more.

An embodiment of the invention can improve existing harvesters, because the long fingers located in the neutral zone on the back side of the flights help avoid the problems of auger wrapping, side draft on fingers and excessive maintenance. It works gathering in the crop and tucking it under the auger so that no reel is needed to force the crop into the header, therefore reducing the reel shatter of soybeans and other shatter sensitive crops, possibly to zero. No reel is needed, because the movement of the header across the growing crops is all that is needed to bring the crops to the sickle, and then to the gathering fingers. In addition it provides an even flow to the combine which is helps with grain saving operations.

The crop free neutral zone may be a well-defined zone on the back side of the flighting, where the paint does not wear off the surface of the auger tube. It diminishes in size as the volume of material increases toward the center feeder section, but generally does not disappear. This neutral zone is relatively void of compressed crop material.

With an embodiment of the invention, fiberglass fingers can be used due to the fact there is no competition between the gathering fingers and the auger flighting.

Any person that has a self propelled grain combine, and wants a header that saves more grain, soybeans or any other shatter prone crop could use an embodiment of the present invention, which could be called “Gather Tuck N Hide.”

An embodiment of this invention is an assist mechanism to enhance and even the flow of crop material to the feeder fingers 44 in the center of the auger tube 12. The work is accomplished by gathering fingers 20 that retract and protract beyond the auger flighting 14 then back to where they protrude slightly from the auger tube 12. The gathering fingers 20 are mounted on a crankshaft 56 by a finger socket 24, which is a socket-bearing combination. The crankshaft 56 consists of a timing and support shaft 54, camclamps 28, center crankshafts 34, bearings 18, bearing flanges 16, clamping bolts & nuts 30 and timing bolt & nuts 30. The camclamps 28 are two parallel split tube units with four clamping bolts& nuts 30 and two timing bolts & nuts 30. Embodiments may include lock collars 32.

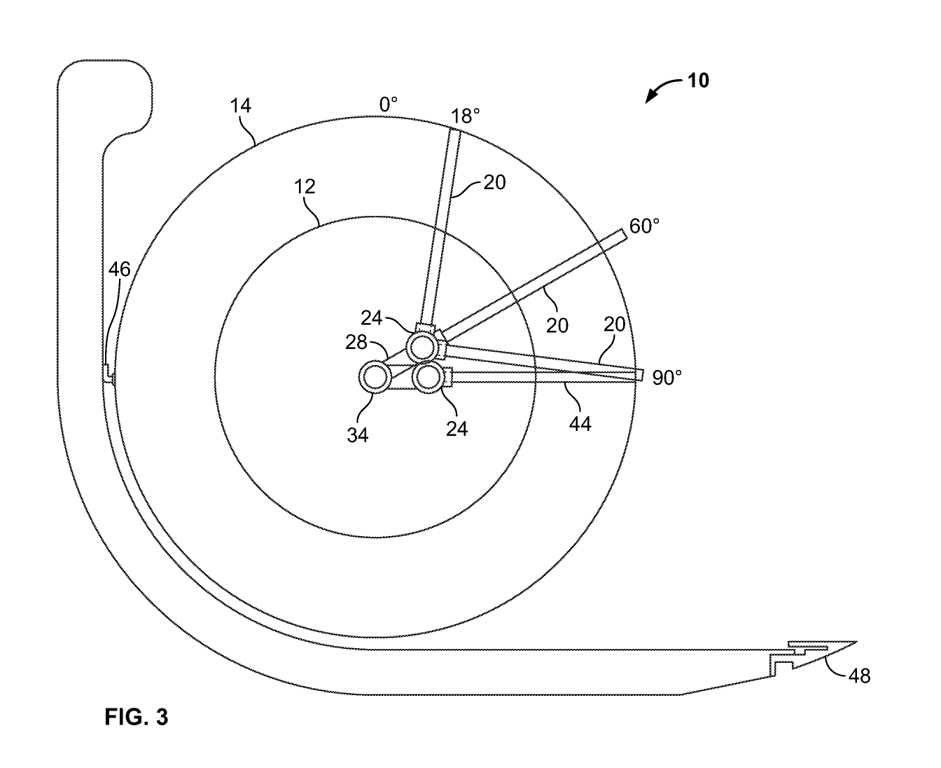

In an embodiment, as the auger tube 12 turns it is the gathering fingers 20, which are timed as shown in FIG. 3, to be totally extended at the most advantageous moment in the cut and gathering operation. The gathering fingers 20 then retract to the neutral area on the back side of the flighting 14 allowing the auger flighting to do, uninhibited the function that it is designed to do. FIG. 3 shows the relative position of the gathering fingers 20 as to the feeder fingers 44. The gathering fingers 20 are advanced 30 degrees ahead of the feeder fingers 44. The function of the gathering fingers is to receive the crop material being cut by the sickle and guards 48 and tuck it under the flighting 14 as it moves the crop material at right angle, compared to its entrance. The feeder fingers 44 must be fully retracted before they reach the position of the stripper bar 46. The function of the feeder fingers 44 is to turn the crop material at a right angle and sweep it to the feeder house & separator. With the top of the auger 13 being considered 0 degrees, the optimum full extension for the gathering fingers 20 is at 60 degrees with a working exposure from 20 degrees to 115 degrees. The optimum extension of the feeder fingers 44 is about 90 degrees, with from 85 to 95 degrees being suitable. The feeder fingers are retracted at about 210 degrees. The split timing along with the gathering fingers 20 retracting into the neutral crop free zone behind the flighting 14 makes it a smooth even flowing crop gathering machine. The 30 degree advance of the gathering fingers could be more, but probably not much less. Suitable ranges would be from 25 degrees to 45 degrees, which would be 55 to 70 degrees relative to vertical.

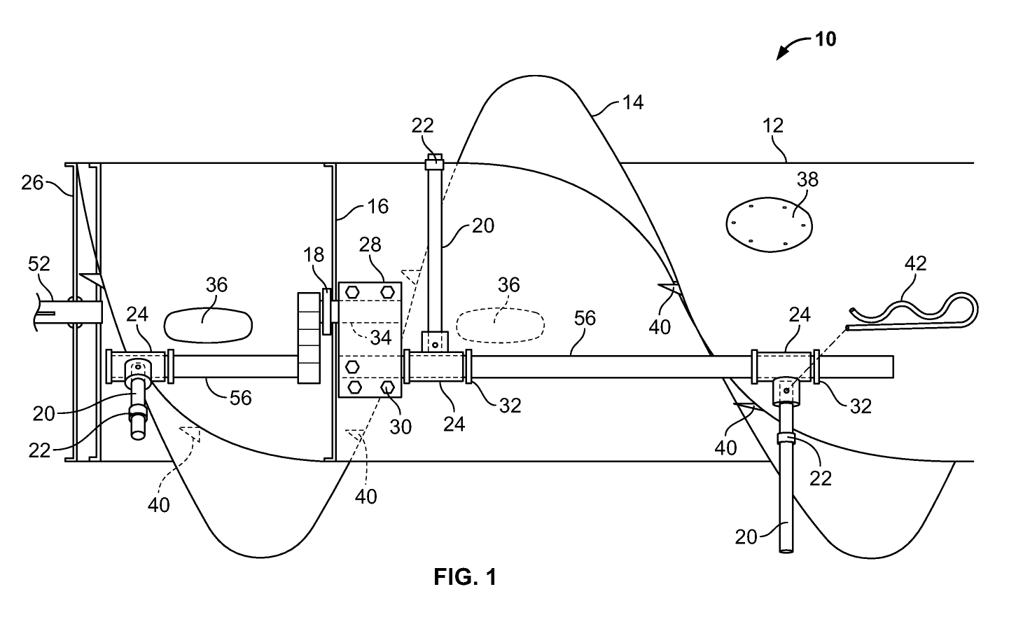

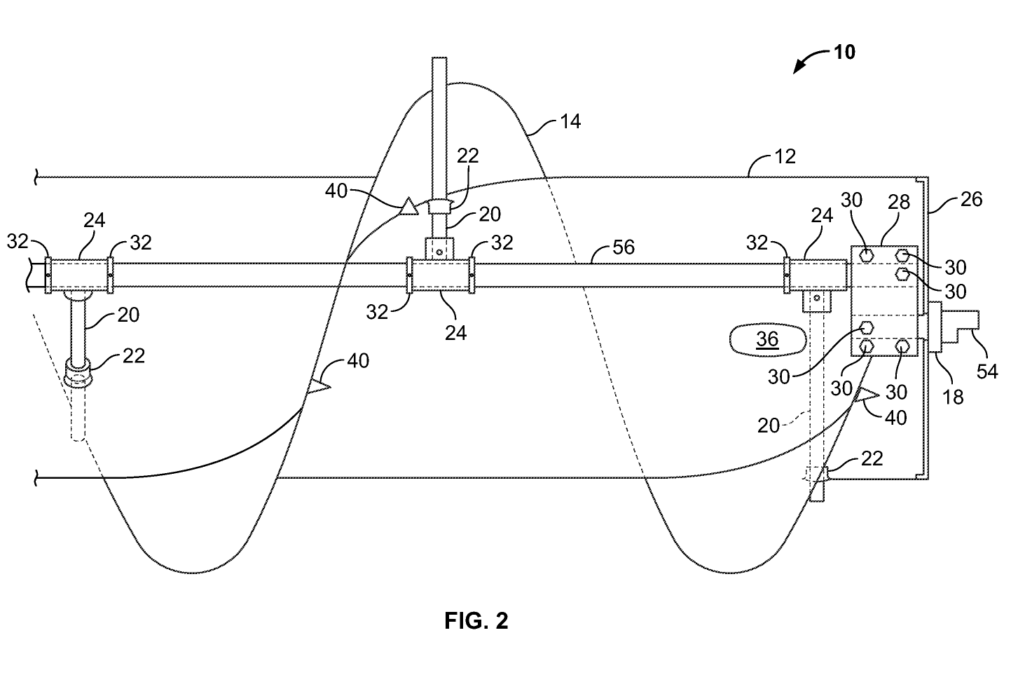

As depicted in the figures, an embodiment of the invention 10 includes an auger tube 12, which is a steel thin walled pipe, from 12 ft. to 35 ft. long, having a diameter of 12 inches to 16 inches. The embodiments of FIGS. 1 and 2 depict a flighting spanning 16 inches. Other embodiments have a flighting spanning 25 inches on a 14 inch auger tube.

An embodiment of the auger tube 12 has three sections: two gathering sections on the sides, with a feeder section in the center. Each gathering section has flighting 14 on its outer surface. Flighting 14 is a strip of sheet metal 4 inches to 7 inches wide spiraling on edge from one end of the auger tube 12 to near the center section. The other end of the auger tube 12 has the flighting 14 spiraling counter to the other end, in the opposite direction. The gather section itself can be composed of sections, which are connected by a center shaft 52 that runs down the axis of the auger tube 12.

When the auger is rotated forward, the crop material will be forced to the center section, also called the feeder section. In an embodiment, the center section is 3 ft. to 4 ft. wide and without flighting. The center section has holes for about 16 finger guides 22, positioned in rows. The feeder fingers 44 may be made of steel.

In an embodiment, the flighting 14 on the gathering sections is braced on the back side with triangular gussets welded to the flighting 14 and the auger tube 12. The gathering section also has holes for finger guides 22, which are made of polyethylene about 2 inches square and 1&½ inches deep with an oblong hole wide enough to accommodate the long fiberglass fingers 20 selected for use. The finger guides 22 are strategically spaced on the back side of the flighting 14, preferably between the braces 40. If the brace 40 is in the way, the guide 22 can be spotted behind the brace and still be in the neutral zone.

In an embodiment, the spacing of the guides 22 begins on one end of the auger tube 12. The first guide 22 is located on the back side of the flighting 14, 6 inches from the end of the auger tube 12. Proceeding, finger guides 22 are located behind the flighting 14, 11& ¾ inches longitudinally to the center section. The other end of the auger tube 12 follows the same pattern, and will result in the finger guides 22 being in a spiraling pattern with a space between the guides 22 for a bearing flange 16 and bearing 18. This pattern will place 28 long fingers 20 on a 30 ft. auger, eight more than full finger augers with fingers located between the flights. An optional spacing of 9 inches apart in the same manner will place 36 long gathering fingers 20 in a 30 ft. auger.

In an embodiment, the long fingers 20 are 15% longer than the feeder fingers 44. The fingers are held in finger sockets 24, which are held on the offset crankshaft 56 by a clip pin 42. The finger sockets 24 may be T-shaped polyurethane self lubricating components. The crankshaft supports the auger tube on the drive end with a center drive shaft 52 welded to an exterior flange 26 and supported by a second flange. The control end of the auger tube is supported with a center crankshaft 34 mounted on a bearing flange 16 and bearing 18. The center crankshaft 34 is secured by an adjustable anchor. The center crankshaft 34 is rotated and timed 30 degrees to the left when connected to a camclamp 28. The offset socket of the camclamp 28 supports a welded crankshaft 56, which is a combined center crankshaft 34 and offset crankshaft 56. The welded crankshaft 56 continues on to a midpoint bearing flange 16 and bearing 18, and then to a camclamp 28 and crankshaft 56 with the center shaft having a timing notch turned 30 degrees to the right. This is connected to a modified camclamp 28, then to the offset center crankshaft 50 connecting to a modified camclamp 28, which connects to a crankshaft 56 with a timing notch turned 30 degrees to the left. This splits the timing of the feeder fingers 44 and the long gathering fingers 20.

The same procedure is continued: camclamp 28, crankshaft 56, camclamp 28 and crankshaft 56. The length is determined so that the center shaft 52 clears and extends beyond the exterior flange 26 by one inch to provide a support shaft 54.

An embodiment may be assembled by having access holes 36 that are oblong oval shaped and located on either side of the internal bearing flanges 16 further separated by 180 degrees for structural integrity. Access hole covers 38 are held in place by 6 self drilling screws. As the system is being assembled, the finger sockets 24 installed on the offset crankshafts 56 must match the number of finger guides 22 in that segment.

In an embodiment, the last components to be installed are the gathering fingers 20 and feeder fingers 44. They are not installed until the auger is installed on a header platform.

In an embodiment, the offset crankshafts 56 can all be welded to the center crankshafts 34 with a spacer. This procedure would eliminate more than half of the cam clamps, make more room for more bearing flanges 16, and would require less time constructing and assembling.

I claim:

1. A device for collecting material, comprising:
a rotatable auger tube having a gathering section;
flighting disposed in a spiral pattern on the outer surface of the gathering section so that, when the auger tube is rotated, the flighting moves material within a perimeter of the flighting laterally and creates a neutral zone behind the flighting that is generally free of material; and
gathering fingers disposed in the neutral zone that, when the auger tube is rotated, extend beyond the perimeter of the flighting to gather the material, tuck the material toward the auger tube, and then retract within the perimeter of the flighting.

2. The device of claim 1, wherein the gathering fingers retract to near the outer surface of the gathering section after gathering the material, so as not to impede lateral movement of material.

3. The device of claim 1, further comprising:
apertures in the neutral zone of the gathering section;
wherein the gathering fingers extend through the apertures and the apertures help guide the gathering fingers into the neutral zone.

4. The device of claim 1, wherein the flighting is a strip of metal spiraling from one end of the gathering section to the other end of the gathering section, and the gathering fingers are composite or fiberglass rods that extend radially from the auger tube.

5. The device of claim 1, further comprising:
a crankshaft inside the auger tube; and
bearings connecting the crankshaft to the gathering fingers;
wherein, when the auger tube rotates, the crankshaft and auger tube cooperate to cause the gathering fingers to extend and retract.

6. The device of claim 5, further comprising:
a center shaft attached to the crankshaft, the center shaft running substantially down the axis of the auger tube; and
a flange;
wherein the center shaft and flange cooperate to support the auger tube.

7. The device of claim 1 further comprising:
a feeder section on the auger tube;
retractable feeder fingers in the feeder section that sweep the material into a collection area, the feeder fingers disposed on the feeder section and the gathering fingers disposed on the gathering section so that, when the auger tube is rotated, the maximum extension of the gathering fingers occurs before the maximum extension of the feeder fingers.

8. The device of claim 7, wherein the material is crops, the device further comprising:
a header adapted to move across the growing crops and receive the crops, the movement of the header across the crops driving the crops into the header; and
a sickle to cut the crops;
wherein the device receives, cuts, and collects the crops.

9. The device of claim 7 wherein the gathering fingers extend away from the auger tube further than the feeder fingers extend from the auger tube.

10. The device of claim 7, wherein the feeder fingers are angled to be fully extended at between 85 and 95 degrees relative to vertical, and the gathering fingers are angled to be fully extended at between 55 and 70 degrees relative to vertical.

11. The device of claim 7, further comprising:
a first crankshaft inside the gathering section of the auger tube to extend and retract the gathering fingers; and
a second crankshaft inside the feeder section of the auger tube to extend and retract the feeder fingers;
wherein the first crankshaft is advanced about its axis is so that the maximum extension of the gathering fingers occurs before the maximum extension of the feeder fingers.

12. The device of claim 1, further comprising:
a second gathering section of the auger tube;
second flighting disposed in a spiral pattern on the outer surface of the second gathering section in the opposite direction of the flighting of the first gathering section, so that, when the auger tube is rotated, the second flighting moves material within a perimeter of the second flighting toward the feeder section and creates a second neutral zone behind the second flighting that is generally free of material; and
second gathering fingers disposed in the second neutral zone that, when the auger tube is rotated, extend beyond the perimeter of the second flighting to gather the material, tuck the material toward the auger tube, and then retract within the perimeter of the second flighting.

13. The device of claim 1, wherein the material is crops, the device further comprising:
a header adapted to move across the growing crops and receive the crops, the movement of the header across the crops driving the crops into the header; and
a sickle to cut the crops;
wherein the device receives, cuts, and collects the crops.

14. A device for collecting material, comprising:
a rotatable auger tube having a gathering section and a feeder section;
flighting disposed in a spiral pattern on the outer surface of the gathering section so that, when the auger tube is rotated, the flighting moves material within a perimeter of the flighting laterally and creates a neutral zone behind the flighting that is generally free of material;
gathering fingers that, when the auger tube is rotated, extend beyond the perimeter of the flighting to gather the material, tuck the material toward the auger tube, and then retract within the perimeter of the flighting;
apertures disposed in the neutral zone of the gathering section that help guide the gathering fingers into the neutral zone; and
retractable feeder fingers in the feeder section that sweep the material into a collection area, the feeder fingers disposed on the feeder section and the gathering fingers disposed on the gathering section so that, when the auger tube is rotated, the maximum extension of the gathering fingers occurs before the maximum extension of the feeder fingers.

15. The device of claim 14, further comprising:
a first crankshaft inside the gathering section of the auger tube to extend and retract the gathering fingers; and
a second crankshaft inside the feeder section of the auger tube to extend and retract the feeder fingers;
wherein the first crankshaft is advanced about its axis is so that the maximum extension of the gathering fingers occurs before the maximum extension of the feeder fingers.

16. A method for collecting material, comprising:
rotating an auger tube having flighting disposed in a spiral pattern in a gathering section of the auger tube so as to move material toward a feeder section of the auger tube;
disposing gathering fingers on the gathering section in a neutral zone behind the flighting that is generally free of material;
extending the gathering fingers beyond the perimeter of the flighting so as to receive the material and tuck the material toward the auger tube; and
retracting the gathering fingers within the perimeter of the flighting.

17. The method of claim 16, wherein the gathering fingers retract to near the outer surface of the gathering section so as to reduce the effect of the gathering fingers against material that is moving toward the feeder section.

18. The method of claim 16, further comprising:
extending and retracting the gathering fingers utilizing a crankshaft inside the auger tube.

19. The method of claim 18, further comprising:
transmitting power from a center drive shaft to the crankshaft; and
rotatably attaching the center drive shaft to a flange so that the center drive shaft and flange cooperate to support the auger tube.

20. The method of claim 16, further comprising:
disposing retractable feeder fingers on the feeder section so that the gathering fingers are advanced ahead of the feeder fingers; and
sweeping the material into a collection area utilizing the feeder fingers.
